(19) United States
(12) Patent Application Publication
(10) Pub. No.: US 2008/0070526 A1
(43) Pub. Date: Mar. 20, 2008

(54) METHOD AND SYSTEM FOR DISTRIBUTING MOBILE BOOK MESSAGES

(75) Inventor: Michael John Donahue, West Palm Beach, FL (US)

Correspondence Address: CHOATE, HALL & STEWART LLP, TWO INTERNATIONAL PLACE, BOSTON, MA, 02110, US

(73) Assignee: Contenta LLC, West Palm Beach, FL (US)

(21) Appl. No.: 11/532,170

(22) Filed: Sep. 15, 2006

(51) Int. Cl. H04B 1/18

(52) U.S. Cl. 455/187.1

(57) ABSTRACT

A system and method for distributing mobile book messages includes generating, by an author, via a graphical user interface, a plurality of messages, each message in the plurality of messages comprising a summary of a section of a work of authorship. The author provides, via the graphical user interface, a schedule for distributing each message in the plurality of messages. A subscriber identifies messages in the plurality of messages for distribution and controls method and frequency of distribution via a second graphical user interface. The subscriber requests, via the second graphical user interface, distribution of the plurality of messages. The subscriber modifies, via the second graphical user interface, the schedule. The subscriber identifies, via the second graphical user interface, a delivery method. Each message in the plurality of messages is distributed to the subscriber responsive to the modified schedule and the delivery method.

### FIELD OF THE INVENTION

The present invention generally relates to mobile book messages. In particular, the present invention relates to a method and system for distributing mobile book messages.

### BACKGROUND OF THE INVENTION

An individual in a traditional educational environment faces many constraints in accomplishing his or her goals. Educational goals in environments such as academia, corporate environments, and self-improvement areas are hampered by traditional learning constraints, including time requirements and distance from the environment. For example, a student wishing to review an academic text typically needs to carry a physical copy of a text, or a large computing device, such as a personal computer, to access an electronic version of the text. Similarly, students preparing for an examination, including continuing education exams, typically carry physical copies of notes, sample examination questions, and other materials. Individuals working in a marketing or sales environment typically similarly carry a physical reminder of the central points of their presentations.

The requirement to carry physical copies of materials, or large computing devices for accessing electronic copies of materials, may inhibit individuals from studying or reviewing materials throughout the day. An individual commuting to and from work or other appointments via public transportation, for example, might have an opportunity to study, but may forego the opportunity, due to the volume of physical texts or to the weight, volume, and power constraints of large personal computing devices required to access his or her study materials.

However, many individuals carry with them small mobile devices. For example, millions of Americans, and billions of people worldwide, carry cell phones. Many of these small mobile devices provide users with text messaging services—the ability to send and receive small amounts of data on a mobile device over a wireless connection. Billions of these short messages are sent to mobile devices every year. The number of users with mobile phones who use text messaging services increases every year, in the United States and worldwide.

Systems for leveraging the use of mobile devices and text messaging to enhance an individual's learning experience and providing opportunities for mobile learning complementary to traditional learning environments would be desirable.

### SUMMARY OF THE INVENTION

In one aspect, a method for distributing mobile book messages includes the step of generating, by an author, via a graphical user interface, a plurality of messages, each message in the plurality of messages comprising a summary of a section of a work of authorship. The author provides, via the graphical user interface, a schedule for distributing each message in the plurality of messages. A subscriber requests, via a second graphical user interface, distribution of the plurality of messages. The subscriber modifies, via the second graphical user interface, the schedule. The subscriber identifies, via the second graphical user interface, a delivery method. Each message in the plurality of messages is distributed to the subscriber responsive to the modified schedule and the delivery method.

In one embodiment, a message in the plurality of messages has a character length of 160 characters. In another embodiment, a message in the plurality of messages comprises a summary of a theme of a book. In still another embodiment, a message in the plurality of messages further comprises a summary of a section of a book.

In one embodiment, the subscriber modifies a frequency of delivery identified by the schedule. In another embodiment, the subscriber requests delivery of all messages in the plurality of messages in a single transmission. In still another embodiment, the subscriber requests transmission of a randomly-selected message from the plurality of messages.

In one embodiment, the subscriber identifies a subset of the plurality of messages for delivery. In another embodiment, the subscriber identifies an address of a mobile device for use in delivering a message via a short message service transmission. In still another embodiment, the subscriber identifies an instant message username for use in delivery a message via an instant message. In still another embodiment, the subscriber identifies an email address for use in delivering a message via email transmission.

In one embodiment, the subscriber identifies a preferred method of delivery. In another embodiment, the subscriber identifies a secondary method of delivery. In still another embodiment, the subscriber receives a message via the secondary method of delivery when an attempt to transmit the message via the preferred method of delivery fails.

In another aspect, a system for distributing mobile book messages includes a plurality of messages, a first graphical user interface, a second graphical user interface, and a transmitter. Each message in the plurality of messages comprises a summary of a section of a work of authorship. The first graphical user interface displays to an author a user interface element for submitting, by the author, at least one of: i) the plurality of messages, ii) a schedule for distributing each message in the plurality of messages, and iii) a request to offer the plurality of messages for distribution. The second graphical user interface displays to a subscriber a user interface element for requesting distribution of the plurality of messages, for modifying the schedule, and for identifying a delivery method. The transmitter distributes to the subscriber each message in the plurality of messages responsive to the modified schedule and the delivery method.

In one embodiment, a message in the plurality of messages has a character length of 160 characters. In another embodiment, a message in the plurality of messages comprises a summary of a theme of a book. In still another embodiment, a message in the plurality of messages further comprises a summary of a section of a book.

In one embodiment, the second graphical user interface comprises a user interface element for modifying an order of delivery of the plurality of messages. In another embodiment, the second graphical user interface comprises a user interface element for requesting transmission of a subset of the plurality of messages. In still another embodiment, the second graphical user interface comprises a user interface element for identifying an address of a mobile device. In yet another embodiment, the second graphical user interface element comprises a user interface element for identifying an instant message username.

### BRIEF DESCRIPTION OF THE FIGURES

The foregoing and other objects, aspects, features, and advantages of the invention will become more apparent and better understood by referring to the following description taken in conjunction with the accompanying drawings, in which:

FIG. 1 is a block diagram depicting a client-server system suitable for practicing one embodiment of a system and method for authoring mobile book message;

FIGS. 2A and 2B are block diagrams depicting embodiments of computers useful in connection with the methods and systems described herein;

FIG. 3 is a flow diagram depicting one embodiment of the steps taken in a method for authoring mobile book messages;

FIG. 4A is a block diagram depicting one embodiment of a system for authoring mobile book messages;

FIG. 4B is a screen shot depicting one embodiment of a user interface element for editing a plurality of mobile book messages;

FIG. 4C is a screen shot depicting one embodiment of a user interface element for setting or modifying a schedule for distribution of the plurality of messages;

FIG. 4D is a screen shot depicting one embodiment of a user interface element for viewing the content of the plurality of messages;

FIG. 5A is a flow diagram depicting one embodiment of the steps taken in a method for authoring SMS-compliant mobile book messages;

FIG. 5B is a screen shot depicting one embodiment of a plurality of SMS-compliant mobile book messages;

FIG. 6A is a block diagram depicting one embodiment of a system for distributing mobile book messages;

FIG. 6B is a screen shot depicting one embodiment of a user interface element for requesting distribution of a plurality of messages;

FIG. 6C is a screen shot depicting one embodiment of a user interface element for identifying destination addresses for use in delivering the plurality of messages to a subscriber;

FIG. 6D is a screen shot depicting one embodiment of a first and second graphical user interface for distributing mobile book messages; and

FIG. 7 is a flow diagram depicting one embodiment of the steps taken in a method for distributing mobile book messages.

### DETAILED DESCRIPTION OF THE INVENTION

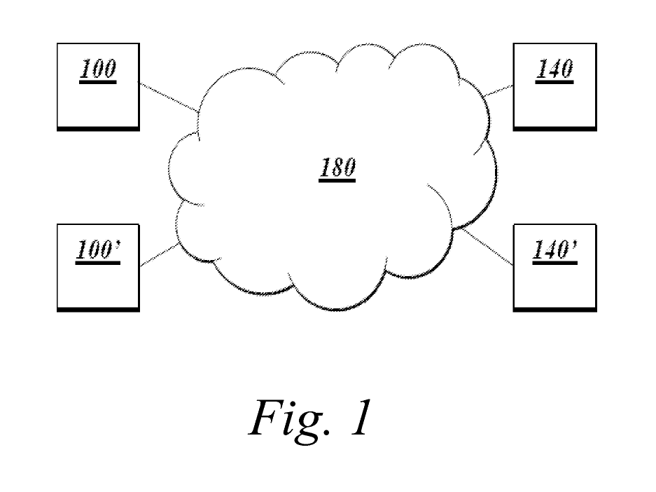

Referring now to FIG. 1, a block diagram depicts one embodiment of a network environment. A first computing device 100, 100′ (generally 100) communicates with a second computing device 140, 140′ (generally 140) over a communications network 180. The topology of the network 180 over which the first devices 100 communicate with the second devices 140 may be a bus, star, or ring topology. The network 180 can be a local area network (LAN), a metropolitan area network (MAN), or a wide area network (WAN) such as the Internet. Although only two first computing devices 100, 100′ and two second computing devices 140, 140′ are depicted in FIG. 1, other embodiments include multiple such devices connected to the network 180.

The first and second devices 100, 140 can connect to the network 180 through a variety of connections including standard telephone lines, LAN or WAN links (e.g., T1, T3, 56 kb, X.25), broadband connections (ISDN, Frame Relay, ATM), and wireless connections. Connections can be established using a variety of communication protocols (e.g., TCP/IP, IPX, SPX, NetBIOS, NetBEUI, SMB, Ethernet, ARCNET, Fiber Distributed Data Interface (FDDI), RS232, IEEE 802.11, IEEE 802.11a, IEEE 802.11b, IEEE 802.11g and direct asynchronous connections). The network connection may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network may comprise a wireless link, such as an infrared channel or satellite band. The topology of the network may be a bus, star, or ring network topology. The network topology may be of any such network or network topology as known to those ordinarily skilled in the art capable of supporting the operations described herein. The network connection may comprise mobile telephone networks utilizing any protocol or protocols used to communicate among mobile devices, including AMPS, TDMA, CDMA, GSM, GPRS or UMTS. In some embodiments, different types of data may be transmitted via different protocols.

The first device 100 may be a personal computer, windows-based terminal, network computer, information appliance, X-device, workstation, mini computer, personal digital assistant, or cell phone. Similarly, the second computing device 140 can be provided as a group of server devices logically acting as a single server system referred to herein as a server farm. In one embodiment, the second computing device 140 is a multi-user server system supporting multiple concurrently active connections from one more first devices 100.

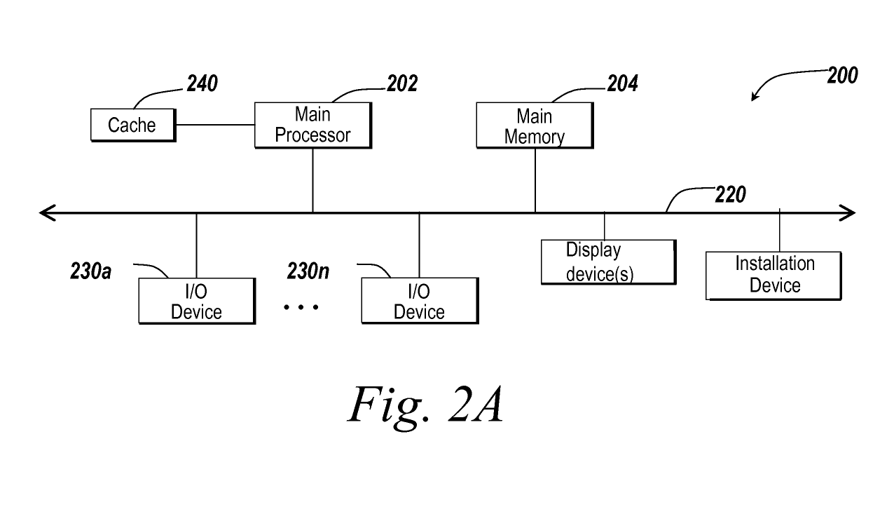

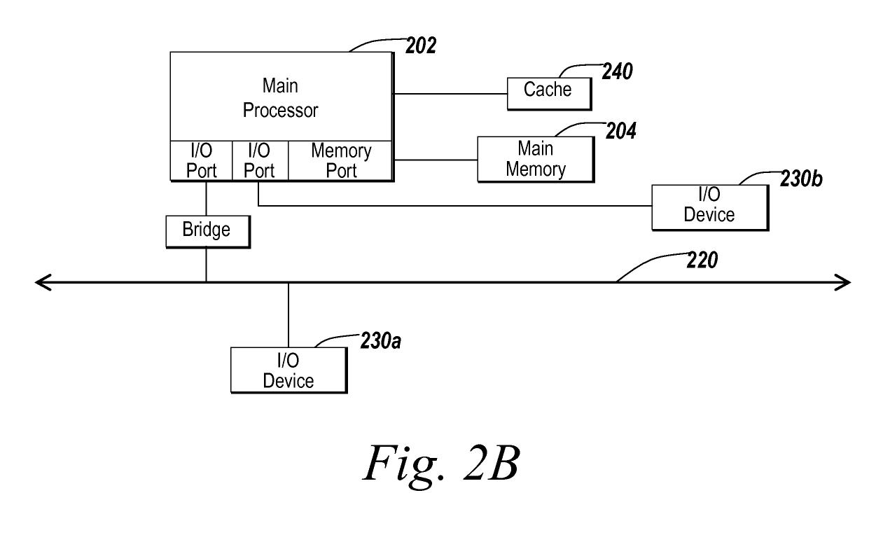

In some embodiments, the first device 100 and the second device 140 are provided as personal computers or computer servers, of the sort manufactured by the Hewlett-Packard Corporation of Palo Alto, Calif. or the Dell Corporation of Round Rock, Tex. FIGS. 2A and 2B depict block diagrams of a typical computer 200 useful as the first device 100 and the second device 140. As shown in FIGS. 2A and 2B, each computer 200 includes a central processing unit 202, and a main memory unit 204. Each computer 200 may also include other optional elements, such as one or more input/output devices 230a-230n (generally referred to using reference numeral 230), and a cache memory 240 in communication with the central processing unit 202.

The central processing unit 202 is any logic circuitry that responds to and processes instructions fetched from the main memory unit 204. In many embodiments, the central processing unit is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; the RS/6000 processor, those manufactured by International Business Machines of White Plains, N.Y.; or those manufactured by Advanced Micro Devices of Sunnyvale, Calif. The computer 200 may be based on any of these processors, or any other processor capable of operating as described herein.

Main memory unit 204 may be one or more memory chips capable of storing data and allowing any storage location to be directly accessed by the microprocessor 202, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM).

In the embodiment shown in FIG. 2A, the processor 202 communicates with main memory 204 via a system bus 220 (described in more detail below). FIG. 2B depicts an embodiment of a computer system 200 in which the processor communicates directly with main memory 204 via a memory port. For example, in FIG. 2B the main memory 204 may be DRDRAM.

FIGS. 2A and 2B depict embodiments in which the main processor 202 communicates directly with cache memory 240 via a secondary bus, sometimes referred to as a “backside” bus. In other embodiments, the main processor 202 communicates with cache memory 240 using the system bus 220. Cache memory 240 typically has a faster response time than main memory 204 and is typically provided by SRAM, BSRAM, or EDRAM.

In the embodiment shown in FIG. 2A, the processor 202 communicates with various I/O devices 230 via a local system bus 220. Various busses may be used to connect the central processing unit 202 to the I/O devices 230, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display, the processor 202 may use an Advanced Graphics Port (AGP) to communicate with the display. FIG. 2B depicts an embodiment of a computer system 200 in which the main processor 202 communicates directly with I/O device 230b via HyperTransport, Rapid I/O, or InfiniBand. FIG. 2B also depicts an embodiment in which local busses and direct communication are mixed: the processor 202 communicates with I/O device 230a using a local interconnect bus while communicating with I/O device 230b directly.

The computer 200 may support an installation device, such as a floppy disk drive for receiving floppy disks such as 3.5-inch, 5.25-inch disks or ZIP disks, a CD-ROM drive, a CD-R/RW drive, a DVD-ROM drive, tape drives of various formats, USB device, hard-drive or any other device suitable for installing software and programs such as a client agent, or portion thereof. The computer 200 may further comprise a storage device, such as one or more hard disk drives or redundant arrays of independent disks, for storing an operating system and other related software, and for storing application software programs such as any program related to a client agent. Optionally, any of the installation devices could also be used as the storage device. Additionally, the operating system and the software can be run from a bootable medium, for example, a bootable CD, such as KNOPPIX®, a bootable CD for GNU/Linux that is available as a GNU/Linux distribution from knoppix.net.

A wide variety of I/O devices 230 may be present in the computer system 200. Input devices include keyboards, mice, trackpads, trackballs, microphones, and drawing tablets. Output devices include video displays, speakers, inkjet printers, laser printers, and dye-sublimation printers. An I/O device may also provide mass storage for the computer system 200 such as a hard disk drive, a floppy disk drive for receiving floppy disks such as 3.5-inch, 5.25-inch disks or ZIP disks, a CD-ROM drive, a CD-R/RW drive, a DVD-ROM drive, tape drives of various formats, and USB storage devices such as the USB Flash Drive line of devices manufactured by Twintech Industry, Inc. of Los Alamitos, Calif.

In some embodiments, the computer 200 may comprise or be connected to multiple display devices, which each may be of the same or different type and/or form. As such, any of the I/O devices 230a-230n may comprise any type and/or form of suitable hardware, software, or combination of hardware and software to support, enable or provide for the connection and use of multiple display devices by the computer 200. For example, the computer 200 may include any type and/or form of video adapter, video card, driver, and/or library to interface, communicate, connect or otherwise use the display devices. In one embodiment, a video adapter may comprise multiple connectors to interface to multiple display devices. In other embodiments, the computer 200 may include multiple video adapters, with each video adapter connected to one or more of the display devices. In some embodiments, any portion of the operating system of the computer 200 may be configured for using multiple displays. In other embodiments, one or more of the display devices may be provided by one or more other computing devices via a network. These embodiments may include any type of software designed and constructed to use another computer's display device as a second display device for the computer 200.

In further embodiments, an I/O device 230 may be a bridge between the system bus 220 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

General-purpose desktop computers of the sort depicted in FIGS. 2A and 2B typically operate under the control of operating systems, which control scheduling of tasks and access to system resources. The computer 200 can be running any operating system such as any of the versions of the Microsoft® Windows operating systems, the different releases of the Unix and Linux operating systems, any version of the Mac OS® for Macintosh computers, any embedded operating system, any real-time operating system, any open source operating system, any proprietary operating system, any operating systems for mobile computing devices, or any other operating system capable of running on the computing device and performing the operations described herein. Typical operating systems include: WINDOWS 3.x, WINDOWS 95, WINDOWS 98, WINDOWS 2000, WINDOWS NT 3.51, WINDOWS NT 4.0, WINDOWS CE, and WINDOWS XP, all of which are manufactured by Microsoft Corporation of Redmond, Wash.; MacOS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, or any type and/or form of a Unix operating system, among others.

In some embodiments, the computer 200 may have different processors, operating systems, and input devices consistent with the device. For example, in one embodiment the computer 200 is a Treo 180, 270, 1060, 600 or 650 smart phone manufactured by Palm, Inc. In this embodiment, the Treo smart phone is operated under the control of the PalmOS operating system and includes a stylus input device as well as a five-way navigator device. In still other embodiments the computer 200 is a mobile device, such as a JAVA-enabled cellular telephone or personal digital assistant (PDA), such as the i55sr, i58sr, i85s, i88s, i90c, i95cl, or the im11000, all of which are manufactured by Motorola Corp. of Schaumburg, Ill., the 6035 or the 7135, manufactured by Kyocera of Kyoto, Japan, or the i300 or i330, manufactured by Samsung Electronics Co., Ltd., of Seoul, Korea. In still other embodiments, the computer 200 is a Blackberry handheld or smart phone, such as the devices manufactured by Research In Motion Limited, including the Blackberry 7100 series, 8700 series, 7700 series, 7200 series, the Blackberry 7520, or the Blackberry Pearl 8100. In yet other embodiments, the computer 200 is a smart phone, Pocket PC, Pocket PC Phone, or other handheld mobile device supporting Microsoft Windows Mobile Software. Moreover, the computer 200 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

In some embodiments, the computer 200 is a portable media player. In one of these embodiments, the computer 200 is a portable media player, such as the Zen Vision W, the Zen Vision series, or the Zen Portable Media Center devices, manufactured by Creative Technologies Ltd. In another of these embodiments, the computer 200 is an MP3 player, such as the Zen line of MP3 players or the Digital, manufactured by Creative Technologies Ltd.

In other embodiments, the computer 200 is a digital audio player. In one of these embodiments, the computer 200 is a digital audio player such as the Apple iPod, iPod mini, iPod Nano, and iPod Shuffle lines of devices, manufactured by Apple Computer of Cupertino, Calif. In another of these embodiments, the digital audio player may also function as a portable media player and as a mass storage device. In still another of these embodiments, the computer 200 is a digital audio player such as the DigitalAudioPlayer Select MP3 players, manufactured by Samsung Electronics America, of Ridgefield Park, N.J., or the Motorola m500 or m25 Digital Audio Players, manufactured by Motorola Inc. of Schaumburg, Ill. In some of these embodiments, the computer 200 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computer 200 comprises a combination of devices, such as a mobile phone combined with a digital audio player or portable media player. In one of these embodiments, the computer 200 is a Motorola RAZR or Motorola ROKR line of combination digital audio players and mobile phones.

In some embodiments, the computer 200 connects to a second computer 200′ on a network using any one of a number of well-known protocols from the GSM or CDMA families, such as W-CDMA. These protocols support commercial wireless communication services and W-CDMA, in particular is the underlying protocol supporting i-Mode and mMode services, offered by NTT DoCoMo.

In some embodiments, the computer 200 communicates with the computer 200′ when providing a user with a service made available by the Global System for Mobile Communications (GSM) standard. In other embodiments, the computer 200 provides a user with a short message service (SMS). In one of these embodiments, the computer 200 may transmit messages to the second computer 200′ via an intermediate computer 200″, such as a short message service center. In another of these embodiments, the computer 200 may transmit messages to the second computer 200′ according to a telecommunications protocol standard for transmitting digital data on a broadband network, such as the Signaling System 7 (SS7) protocol. In still other embodiments, the computer 200 transmits enhanced short messages to the computer 200′.

In other embodiments, the computer 200 transmits text messages to the computer 200′. In one of these embodiments, the text messages comply with the GSM standard for short messages. In another of these embodiments, the computers 200, 200′, 200″ transmit text messages that do not comply with a GSM standard. In still another of these embodiments, the computer 200 transmits text messages over a control channel between the computer 200 and a cell phone tower, which forwards the text messages to the recipient computer 200′.

In some embodiments, an author interacts with a graphical user interface and generates a plurality of messages. In other embodiments, a message in the plurality of messages comprises a summary of an essential idea of a section of a work of authorship described in a short text message. In one of these embodiments, the message complies with the short message service standard. In still other embodiments, each message in the plurality of messages comprises a summary of a section of a work of authorship and the plurality of messages together comprise a summary of the entire work of authorship which may be distributed to users. In one of these embodiments, the summary may be distributed one message, or section of the work of authorship, at a time. In another of these embodiments, multiple messages, or sections of the work of authorship, may be distributed in a single transmission to a user. In still another of these embodiments, a user specifies a method for distribution of the plurality of messages, for example, by requesting distribution according to chapter, theme, or topic.

In some embodiments, distribution of a plurality of messages assists individuals seeking to learn more effectively. In one of these embodiments, books from leading authors and educators are distilled into “best-messages” called mBooks, or mobile books, which are sent to individuals' mobile phones, personal digital assistants, instant messenger accounts or email accounts. In another of these embodiments, an individual subscribes to a service delivering a mobile book comprising a plurality of text messages to one or more of the individual's mobile devices. In still another of these embodiments, the subscriber controls delivery times, schedule, and frequency, can generate playlists and specifies target devices and methods of delivery of the mobile content. In other embodiments, the plurality of messages comprises an electronic distillation of a text, optimized for delivery to mobile devices. In still other embodiments, the plurality of “best messages” summarizes text books, lectures, course materials, exam preparation, self-help books, religious texts, academic texts, corporate training materials, sales and marketing materials, and a wide-range of content providing educational, professional and spiritual development.

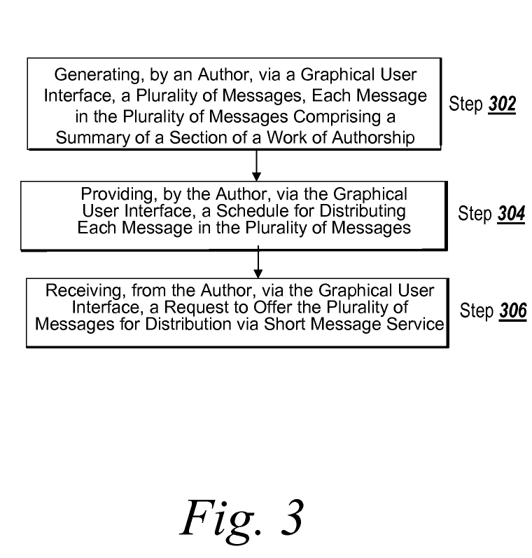

Referring now to FIG. 3, a flow diagram depicts one embodiment of the steps taken in a method for authoring mobile book messages. In brief overview, an author generates, via a graphical user interface, a plurality of messages, each message in the plurality of messages comprising a summary of a section of a work of authorship (step 302). The author provides, via the graphical user interface, a schedule for distributing each message in the plurality of messages (step 304). A request to offer the plurality of messages for distribution via short message service is received from the author via the graphical user interface (step 306).

Referring now to FIG. 3, and in greater detail, an author generates, via a graphical user interface, a plurality of messages, each message in the plurality of messages comprising a summary of a section of a work of authorship (step 302). In one embodiment, the author generates, via the graphical user interface, a plurality of messages comprising a summary of a section of a book. In another embodiment, the author generates, via the graphical user interface, a plurality of messages comprising a summary of a section of a training manual. In still another embodiment, the author generates, via the graphical user interface, a plurality of messages comprising a summary of a section of a self-help book. In yet another embodiment, the author generates, via the graphical user interface, a plurality of messages comprising a summary of a section of a religious text.

In one embodiment, the author generates, via the graphical user interface, a message in the plurality of messages comprising a quote from the work. In another embodiment, the author generates, via the graphical user interface, a plurality of messages, a message in the plurality of messages comprising a test question. In still another embodiment, the author generates, via the graphical user interface, a plurality of messages, a message in the plurality of messages comprising a response to the test question.

In one embodiment, the author composes, via the graphical user interface, a message in the plurality of messages. In another embodiment, the author edits, via the graphical user interface, a message in the plurality of messages. In still another embodiment, the author adds, via the graphical user interface, a message to the plurality of messages. In yet another embodiment, the author imports, via the graphical user interface, a message from a second plurality of messages into the plurality of messages.

In some embodiments, a mobile book comprises the plurality of messages. In one of these embodiments, the mobile book comprises a plurality of chapters. In another of these embodiments, the author creates a chapter comprising a subset of the plurality of messages via the graphical user interface. In still another of these embodiments, the author edits a chapter via the graphical user interface. In still another of these embodiments, the author deletes a chapter via the graphical user interface. In yet another of these embodiments, the author modifies an order of a plurality of chapters via the graphical user interface. In a further of these embodiments, the author modifies, deletes, edits, or modifies an order of a quote within a chapter. In other embodiments, the author views a preview of a quote, chapter or mobile book.

In one embodiment, the author generates, via the graphical user interface, a plurality of messages organized by chapter. In still another embodiment, the author generates, via the graphical user interface, a plurality of messages organized by theme.

The author provides, via the graphical user interface, a schedule for distributing each message in the plurality of messages (step 304). In one embodiment, the author provides, via the graphical user interface, an order of distribution of the messages in the plurality of messages. In another embodiment, the author provides, via the graphical user interface, a suggested schedule for distributing each message in the plurality of messages.

A request to offer the plurality of messages for distribution via short message service is received from the author via the graphical user interface (step 306). In one embodiment, a summary of the plurality of messages is displayed on a web site in response to the request to offer the plurality of messages for distribution. In another embodiment, a graphical user interface displays the summary on the web site. In still another embodiment, the plurality of messages is made available for sale. In yet another embodiment, the plurality of messages is made available for retrieval by a subscriber responsive to the request. In a further embodiment, the plurality of messages is made available for sale to a subscriber responsive to the request.

In some embodiments, the plurality of messages is added to a library storing pluralities of messages, responsive to the request to offer the plurality of messages for distribution. In one of these embodiments, the plurality of messages is added to a database. In another of these embodiments, the library comprises a plurality of stored pluralities of messages. In still another of these embodiments, a graphical user interface allows a user to browse summaries of the pluralities of messages stored in the library.

In one embodiment, the request is received with a suggested price. In another embodiment, a copy of the plurality of messages is made available for sale at the suggested price. In still another embodiment, a subscriber agrees to pay the suggested price for distribution of a copy of the plurality of messages.

In one embodiment, a request is received to translate the plurality of messages from a first language to a second language. In another embodiment, the author translates the plurality of messages from the first language to the second language, via the graphical user interface. In still another embodiment, the author generates a translated plurality of messages, via the graphical user interface.

In one embodiment, a request to offer the plurality of messages for distribution to a limited set of users is received from the author via the graphical user interface. In another embodiment, the author requests distribution of the plurality of messages to the limited set of users, the plurality of messages summarizing confidential works of authorship. In still another embodiment, the author requests distribution of the plurality of messages to the limited set of users, the plurality of messages encrypted prior to distribution.

In some embodiments, the plurality of messages distributed to the limited set of users comprises summaries of training materials. In other embodiments, the plurality of messages distributed to the limited set of users comprises summaries of sales and marketing materials. In still other embodiments, the plurality of messages distributed to the limited set of users comprises summaries of financial information. In yet other embodiments, the plurality of messages distributed to the limited set of users comprises summaries of confidential company information.

In one embodiment, the limited set of users is affiliated with the author. In another embodiment, the limited set of users and the author share an employer. In still another embodiment, the limited set of users is employed by the author.

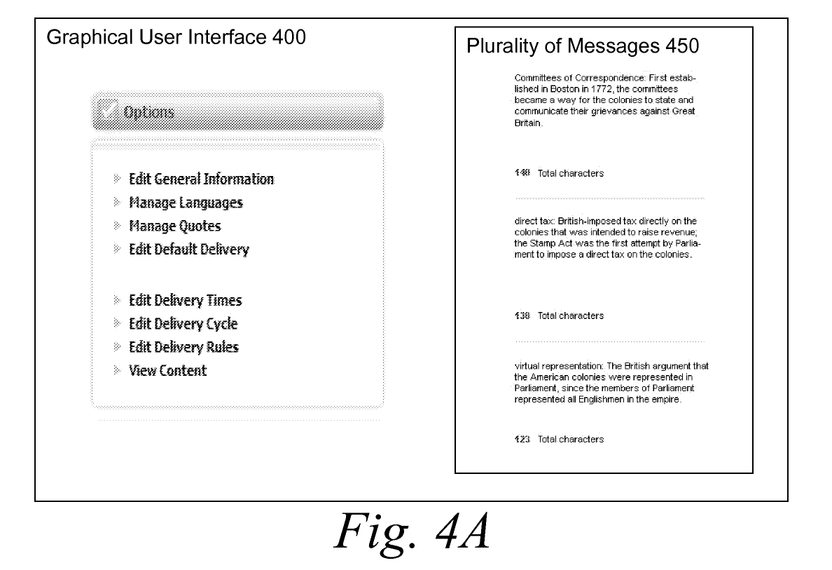

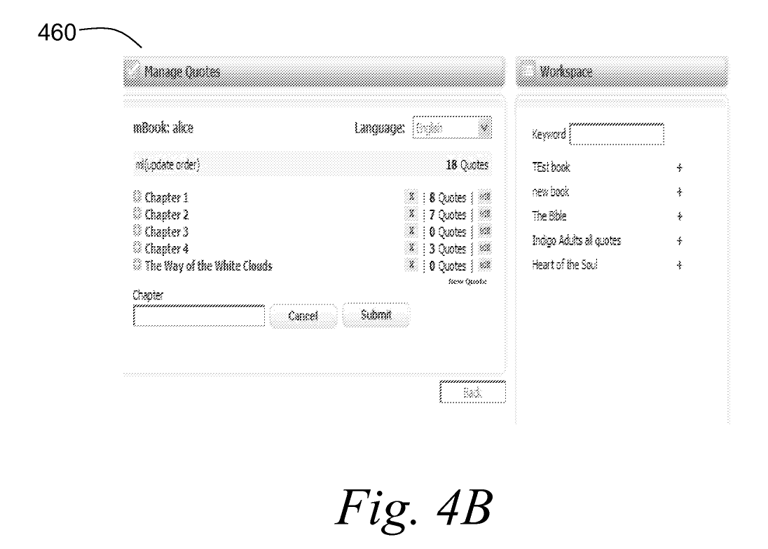

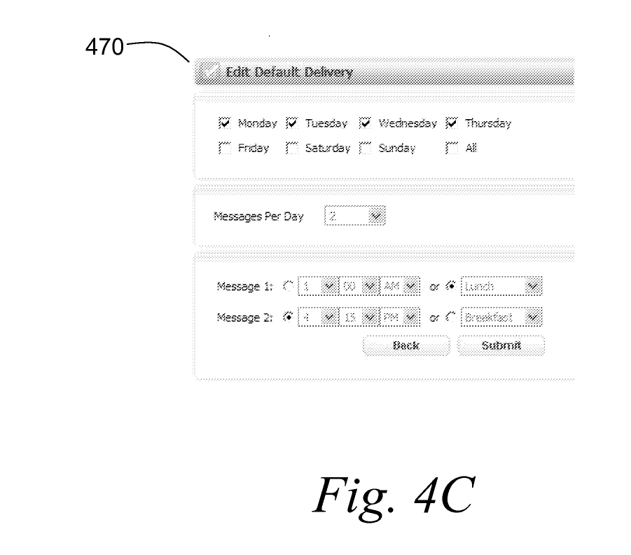

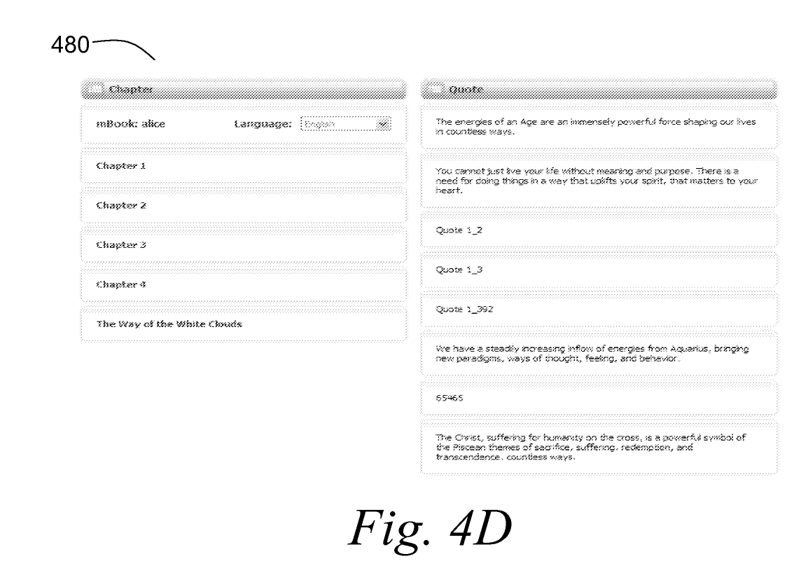

Referring now to FIG. 4A, a block diagram depicts one embodiment of a system for authoring mobile book messages. In brief overview, the system includes a graphical user interface 400 and a plurality of messages 450. Each message in the plurality of messages 450 comprises a summary of a section of a work of authorship. The graphical user interface 400 displays to an author a user interface element for submitting, by the author, at least one of i) the plurality of messages 450, ii) a schedule for distributing each message in the plurality of messages 450, and iii) a request to offer the plurality of messages 450 for distribution.

Referring now to FIG. 4A, and in greater detail, the system includes a plurality of messages 450, each message in the plurality of messages 450 comprises a summary of a section of a work of authorship. In one embodiment, a message in the plurality of messages 450 has a character length of 160 characters. In another embodiment, a message in the plurality of messages 450 has a character length of 70 characters when non-Latin alphabets, such as Arabic and Chinese, are used. In still another embodiment, a display is provided of the number of total characters in the message in the plurality of messages 450.

In one embodiment, a message in the plurality of messages 450 comprises a summary of a theme of a book. In another embodiment, a message in the plurality of messages 450 comprises a summary of a section of a book. In still another embodiment, a message in the plurality of messages 450 comprises a summary of a section of a training manual. In yet another embodiment, a message in the plurality of messages 450 comprises a summary of a section of a self-help book.

In one embodiment, a message in the plurality of messages 450 comprises a summary of a section of a religious text. In another embodiment, a message in the plurality of messages 450 comprises a quote from the work. In still another embodiment, a message in the plurality of messages 450 comprises a test question. In yet another embodiment, a message in the plurality of messages 450 further comprises response to the test question.

The graphical user interface 400 displays to an author a user interface element for submitting, by the author, at least one of i) the plurality of messages 450, ii) a schedule for distributing each message in the plurality of messages 450, and iii) a request to offer the plurality of messages 450 for distribution. In one embodiment, the graphical user interface 400 displays to an author a user interface element for editing the plurality of messages 450. As depicted in FIG. 4A, in some embodiments, the graphical user interface 400 displays to the author user interface elements for managing the plurality of messages 450, referred to in FIG. 4A as quotes, and for managing the language in which the quotes are provided. In another embodiment, the graphical user interface 400 displays to an author a user interface element for setting or modifying a schedule for distribution of the plurality of messages 450. As depicted in FIG. 4A, in some embodiments, the graphical user interface 400 displays to the author user interface elements for editing a default delivery schedule, for editing a time of delivery, for editing a delivery cycle, or for editing rules for delivery. In still another embodiment, the graphical user interface 400 displays to the author a user interface element for viewing the content of the plurality of messages 450. In yet another embodiment, the graphical user interface 400 includes a user interface element displaying a summary of the plurality of messages 450 to a subscriber.

Referring now to FIG. 4B, a screen shot depicts one embodiment of a user interface element 460 for editing the plurality of messages 450. In one embodiment, the graphical user interface 400 provides the user interface element 460 for editing the plurality of messages. In another embodiment, the user interface element 460 provides the author with a user interface element for composing, by the author, via the graphical user interface 400, a message in the plurality of messages 450. In another embodiment, the graphical user interface 400 includes a user interface element 460 for editing, by the author, via the graphical user interface 400, a message in the plurality of messages 450. In still another embodiment, the graphical user interface 400 includes a user interface element 460 for adding, by the author, via the graphical user interface 400, a message to the plurality of messages 450. In some embodiments, the graphical user interface 400 includes a user interface element 460 for importing, by the author, via the graphical user interface 400, a message from a second plurality of messages 450′ into the plurality of messages 450. In other embodiments, the author uploads, via the graphical user interface 400, a message authored using a spreadsheet program.

As depicted in FIG. 4B, in one embodiment, the user interface element may provide the author with the ability to update the order in which the plurality of messages are organized. In one embodiment, the graphical user interface 400 includes a user interface element 460 for generating, by the author, via the graphical user interface 400, a plurality of messages 450 organized by chapter. In another embodiment, the graphical user interface 400 includes a user interface element 460 for generating, by the author, via the graphical user interface 400, a plurality of messages 450 organized by theme.

Referring now to FIG. 4C, a screen shot depicts one embodiment of a user interface element 470 for setting or modifying a schedule for distribution of the plurality of messages 450. In one embodiment, the graphical user interface 400 includes a user interface element 470 for providing, by the author, via the graphical user interface 400, a suggested schedule for distributing each message in the plurality of messages 450. In another embodiment, the graphical user interface 400 includes a user interface element 470 for providing, by the author, via the graphical user interface 400, an order of distribution of the messages in the plurality of messages 450. In some embodiments, the author may select a chronological time for distribution of a message in the plurality of messages 450. In other embodiments, the author may select a description of a time frame (such as “lunch” or “breakfast”). In still other embodiments, the author may select a number of messages in the plurality of messages 450 to be distributed per day.

Referring now to FIG. 4D, a screen shot depicts one embodiment of a user interface element for viewing the content of the plurality of messages 450. In one embodiment, the plurality of messages 450 is displayed in order by chapter. In another embodiment, a user interface element allows an author to view the plurality of messages 450 according to the language in which the quotes are written.

In one embodiment, the system includes a library storing pluralities of messages. In another embodiment, the graphical user interface 400 includes a user interface element for making the plurality of messages 450 available for retrieval by a subscriber. In still another embodiment, the graphical user interface 400 includes a user interface element for making the plurality of messages 450 available for sale. In yet another embodiment, the graphical user interface 400 includes a user interface element for receiving, from the author, via the graphical user interface 400, a suggested price. In a further embodiment, the graphical user interface 400 includes a user interface element for offering the plurality of messages 450 for sale at the suggested price. In some embodiments, the graphical user interface 400 comprises a user interface element for receiving, from the author, via the graphical user interface 400, a request to offer the plurality of messages 450 for distribution to a limited set of users. In other embodiments, the graphical user interface 400 includes a user interface element for translating the plurality of messages 450 from a first language to a second language.

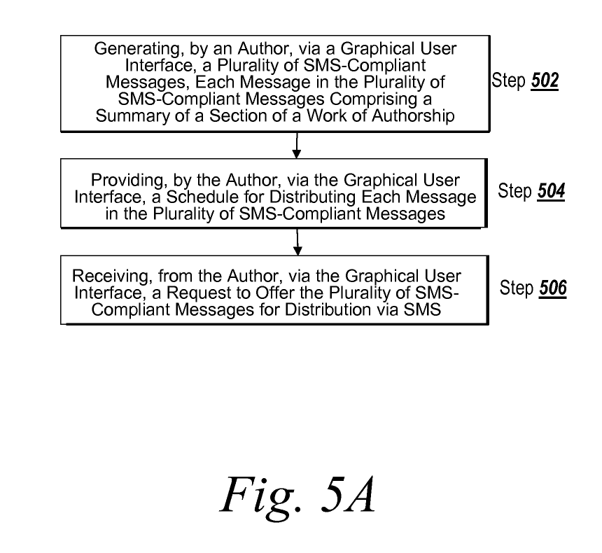

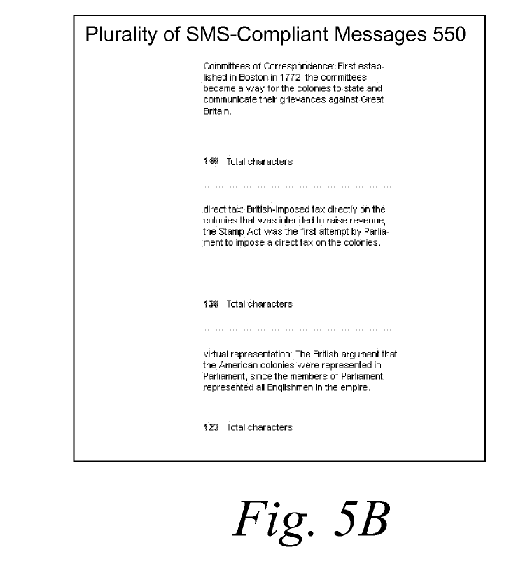

Referring now to FIG. 5A, flow diagram depicts one embodiment of the steps taken in a method for authoring SMS-compliant mobile book messages. In brief overview, an author generates, via a graphical user interface, a plurality of SMS-compliant messages, each message in the plurality of SMS-compliant messages comprising a summary of a section of a work of authorship (step 502). The author provides, via the graphical user interface, a schedule for distributing each message in the plurality of SMS-compliant messages (step 504). A request to offer the plurality of SMS-compliant messages for distribution via short message service is received from the author via the graphical user interface (step 506).

Referring now to FIG. 5A, and in greater detail, an author generates, via a graphical user interface, a plurality of SMS-compliant messages, each message in the plurality of SMS-compliant messages comprising a summary of a section of a work of authorship (step 502). In one embodiment, the author generates, via the graphical user interface, a plurality of SMS-compliant messages comprising a summary of a section of a book. In another embodiment, the author generates, via the graphical user interface, a plurality of SMS-compliant messages comprising a summary of a section of a training manual. In still another embodiment, the author generates, via the graphical user interface, a plurality of SMS-compliant messages comprising a summary of a section of a self-help book. In yet another embodiment, the author generates, via the graphical user interface, a plurality of SMS-compliant messages comprising a summary of a section of a religious text.

In one embodiment, the author generates, via the graphical user interface, a message in the plurality of SMS-compliant messages comprising a quote from the work. In another embodiment, the author generates, via the graphical user interface, a plurality of messages, a message in the plurality of SMS-compliant messages comprising a test question. In still another embodiment, the author generates, via the graphical user interface, a plurality of SMS-compliant messages, a message in the plurality of SMS-compliant messages comprising a response to the test question.

In one embodiment, the author composes, via the graphical user interface, a message in the plurality of SMS-compliant messages. In another embodiment, the author edits, via the graphical user interface, a message in the plurality of SMS-compliant messages. In still another embodiment, the author adds, via the graphical user interface, a message to the plurality of SMS-compliant messages. In yet another embodiment, the author imports, via the graphical user interface, a message from a second SMS-compliant plurality of messages into the plurality of SMS-compliant messages.

In some embodiments, a mobile book comprises the plurality of SMS-compliant messages. In one of these embodiments, the mobile book comprises a plurality of chapters. In another of these embodiments, the author creates a chapter comprising a subset of the plurality of SMS-compliant messages via the graphical user interface. In still another of these embodiments, the author edits a chapter via the graphical user interface. In still another of these embodiments, the author deletes a chapter via the graphical user interface. In yet another of these embodiments, the author modifies an order of a plurality of chapters via the graphical user interface. In a further of these embodiments, the author modifies, deletes, edits, or modifies an order of a quote within a chapter. In other embodiments, the author views a preview of a quote, chapter or mobile book.

In one embodiment, the author generates, via the graphical user interface, a plurality of SMS-compliant messages organized by chapter. In still another embodiment, the author generates, via the graphical user interface, a plurality of SMS-compliant messages organized by theme.

The author provides, via the graphical user interface, a schedule for distributing each message in the plurality of SMS-compliant messages (step 504). In one embodiment, the author provides, via the graphical user interface, an order of distribution of the messages in the plurality of SMS-compliant messages. In another embodiment, the author provides, via the graphical user interface, a suggested schedule for distributing each message in the plurality of SMS-compliant messages.

A request to offer the plurality of SMS-compliant messages for distribution via short message service is received from the author via the graphical user interface (step 306). In one embodiment, a summary of the plurality of SMS-compliant messages is displayed on a web site in response to the request to offer the plurality of SMS-compliant messages for distribution. In another embodiment, a graphical user interface displays the summary on the web site. In still another embodiment, the plurality of SMS-compliant messages is made available for sale. In yet another embodiment, the plurality of SMS-compliant messages is made available for retrieval by a subscriber responsive to the request. In a further embodiment, the plurality of SMS-compliant messages is made available for sale to a subscriber responsive to the request.

In some embodiments, the plurality of SMS-compliant messages is added to a library storing pluralities of messages, responsive to the request to offer the plurality of SMS-compliant messages for distribution. In one of these embodiments, the plurality of SMS-compliant messages is added to a database. In another of these embodiments, the library comprises a plurality of stored pluralities of SMS-compliant messages. In still another of these embodiments, a graphical user interface allows a user to browse summaries of the pluralities of SMS-compliant messages stored in the library.

In one embodiment, the request is received with a suggested price. In another embodiment, a copy of the plurality of SMS-compliant messages is made available for sale at the suggested price. In still another embodiment, a subscriber agrees to pay the suggested price for distribution of a copy of the plurality of SMS-compliant messages.

In one embodiment, a request is received to translate the plurality of SMS-compliant messages from a first language to a second language. In another embodiment, the author translates the plurality of SMS-compliant messages from the first language to the second language, via the graphical user interface. In still another embodiment, the author generates a translated plurality of SMS-compliant messages, via the graphical user interface.

In one embodiment, a request to offer the plurality of SMS-compliant messages for distribution to a limited set of users is received from the author via the graphical user interface. In another embodiment, the author requests distribution of the plurality of SMS-compliant messages to the limited set of users, the plurality of SMS-compliant messages summarizing confidential works of authorship. In still another embodiment, the author requests distribution of the plurality of SMS-compliant messages to the limited set of users, the plurality of SMS-compliant messages encrypted prior to distribution.

In some embodiments, the plurality of SMS-compliant messages distributed to the limited set of users comprises summaries of training materials. In other embodiments, the plurality of SMS-compliant messages distributed to the limited set of users comprises summaries of sales and marketing materials. In still other embodiments, the plurality of SMS-compliant messages distributed to the limited set of users comprises summaries of financial information. In yet other embodiments, the plurality of SMS-compliant messages distributed to the limited set of users comprises summaries of confidential company information. In one embodiment, the limited set of users is affiliated with the author. In another embodiment, the limited set of users and the author share an employer. In still another embodiment, the limited set of users is employed by the author.

Referring now to FIG. 5B, a screen shot depicts one embodiment of a plurality of SMS-compliant mobile book messages. Each message in the plurality of SMS-compliant messages 550 comprises a summary of a section of a work of authorship. In one embodiment, a message in the plurality of SMS-compliant messages 550 has a character length of 160 characters. In another embodiment, a message in the plurality of SMS-compliant messages 550 has a character length of 70 characters when non-Latin alphabets, such as Arabic and Chinese, are used. In still another embodiment, a display is provided of the number of total characters in the message in the plurality of SMS-compliant messages 550.

In one embodiment, a message in the plurality of SMS-compliant messages 550 comprises a summary of a theme of a book. In another embodiment, a message in the plurality of SMS-compliant messages 550 comprises a summary of a section of a book. In still another embodiment, a message in the plurality of SMS-compliant messages 550 comprises a summary of a section of a training manual. In yet another embodiment, a message in the plurality of SMS-compliant messages 550 comprises a summary of a section of a self-help book. In some embodiments, a message in the plurality of SMS-compliant messages 550 comprises an essential idea of a section of a work of authorship described in a short message.

In one embodiment, a message in the plurality of SMS-compliant messages 550 comprises a summary of a section of a religious text. In another embodiment, a message in the plurality of SMS-compliant messages 550 comprises a quote from the work. In still another embodiment, a message in the plurality of SMS-compliant messages 550 comprises a test question. In yet another embodiment, a message in the plurality of SMS-compliant messages 550 further comprises response to the test question.

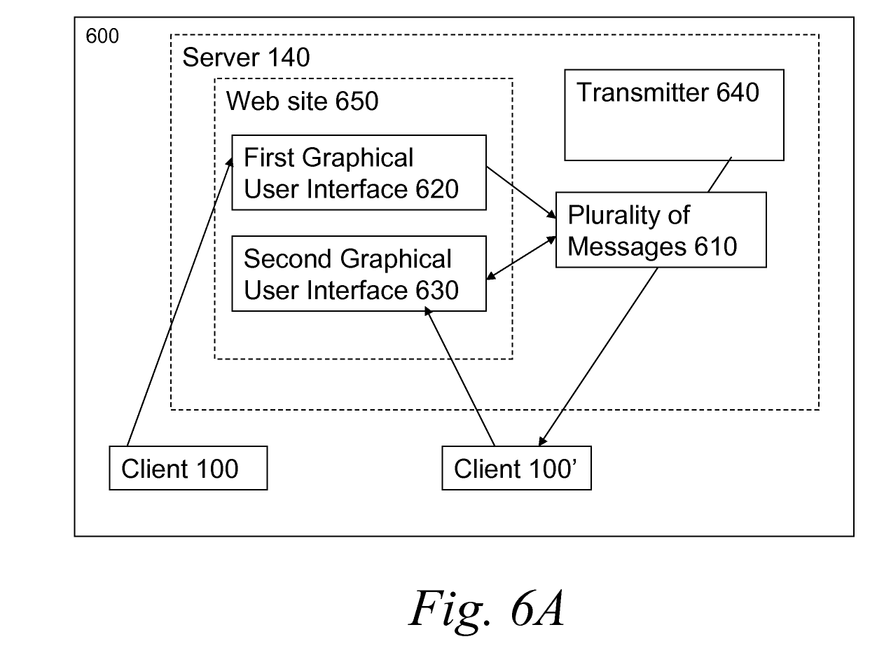

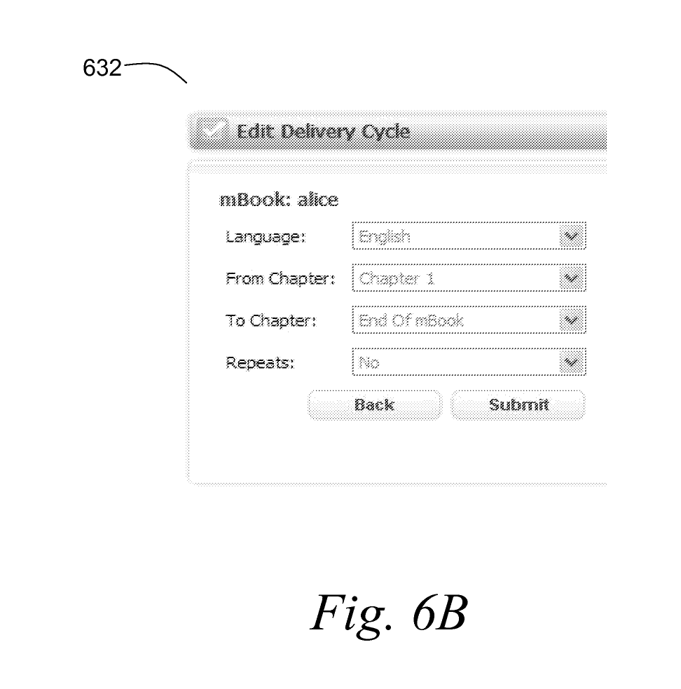

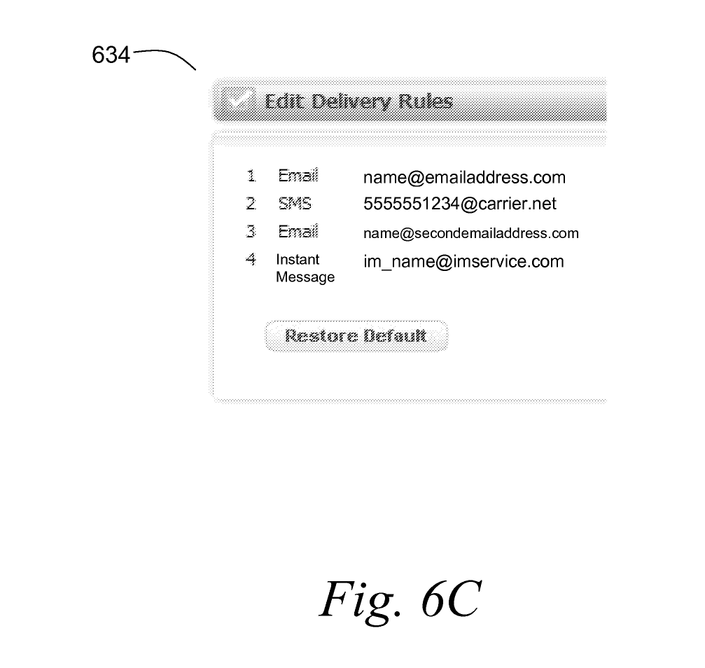

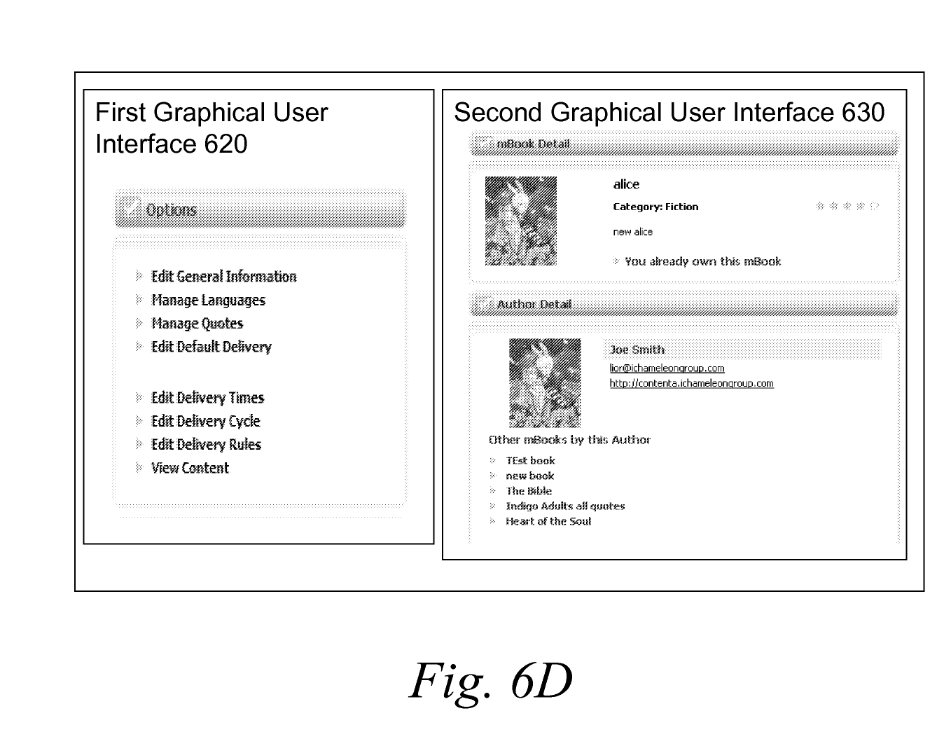

Referring now to FIG. 6A, a block diagram depicts one embodiment of a system for distributing mobile book messages. In brief overview, the system 600 for distributing mobile book messages includes a plurality of messages 610, a first graphical user interface 620, a second graphical user interface 630, and a transmitter 640. Each message in the plurality of messages 610 comprises a summary of a section of a work of authorship. The first graphical user interface 620 displays to an author a user interface element for submitting, by the author, i) the plurality of messages 610, ii) a schedule for distributing each message in the plurality of messages 610, and iii) a request to offer the plurality of messages 610 for distribution. The second graphical user interface 630 displays to a subscriber a user interface element for requesting distribution of the plurality of messages 610, for modifying the schedule, and for identifying a delivery method. The transmitter 640 distributes to the subscriber, each message in the plurality of messages 610, responsive to the modified schedule and the delivery method.

Referring now to FIG. 6A, and in greater detail, the system includes a first graphical user interface 620 and a second graphical user interface 630. In one embodiment, depicted in shadow in FIG. 6A, a web site 650 displays the first graphical user interface 620 and the second graphical user interface 630 to an author. In another embodiment, the website 650 displays the graphical user interfaces to a subscriber.

In one embodiment, an author of a plurality of messages 610 connects to a server 140 from a client 100 to create or modify the plurality of messages 610 via the first graphical user interface 620. In another embodiment, a user of a client 100′ connects to a server 140 to request distribution of a plurality of messages 610. In still another embodiment, the user connects to the server 140 to purchase a copy of the plurality of messages 610 via the second graphical user interface 630. In yet another embodiment, the user connects to the server 140 to subscribe to a service for distribution of messages in a purchased plurality of messages 610 via the second graphical user interface 630. In a further embodiment, the user connects to the server 140 to modify a subscription via the second graphical user interface 630.

In one embodiment, a server 140, as depicted in FIG. 1, displays a web site 650 to one or more clients 100. In another embodiment, a server 140 includes a transmitter 640 for distributing messages in the plurality of messages 610 to one or more clients 100. In still another embodiment, the server 140 is a web server and provides access to the web site 650. In yet another embodiment, the transmitter 640 resides on a separate transmitter 640. In some embodiments, a client 100 is both an author of a plurality of messages 610 and a subscriber of a distribution service, receiving messages in the plurality of messages 610, or messages from a second plurality of messages 610′.

Each message in the plurality of messages 610 comprises a summary of a section of a work of authorship. In some embodiments, the plurality of messages 610 comprises a plurality of SMS-compliant messages, such as the plurality of SMS-compliant messages 550, described above in connection with FIG. 5B. In other embodiments, the plurality of messages 610 comprises a plurality of text messages. In still other embodiments, the plurality of messages 610 comprises a plurality of message 450, as described above in connection with FIG. 4A.

In some embodiments, the plurality of messages 610 comprises a summary of a book or text in the public domain. In one of these embodiments, the summary is of a Buddhist, Christian, Hindu, Islamic, Taoist, Zen, or other religious text. In another of these embodiments, the plurality of messages summarizes an academic text selected from areas such as history, sociology, anthropology, and philosophy. In still another of these embodiments, the plurality of messages summarizes entries in encyclopedias, dictionaries, or thesauri. In yet another of these embodiments, the plurality of messages summarizes examination preparation material, such as materials related to Series 7 examinations, Real Estate examinations, SAT examinations, GMAT examinations, LSAT examinations, Bar examinations, certification programs, and other examinations.

The first graphical user interface 620 displays to an author a user interface element for submitting, by the author, i) the plurality of messages 610, ii) a schedule for distributing each message in the plurality of messages 610, and iii) a request to offer the plurality of messages 610 for distribution. In one embodiment, the first graphical user interface 620 comprises a graphical user interface 400 as described above in connection with FIG. 4A. In another embodiment, the first graphical user interface 620 includes the user interface elements described in connection with FIGS. 4B, 4C, and 4D, enabling an author to manage, modify, display, and specify distribution schedules for a plurality of messages 610.

The second graphical user interface 630 displays to a subscriber a user interface element for requesting distribution of the plurality of messages 610, for modifying the schedule, and for identifying a delivery method. In some embodiments, the second graphical user interface 630 includes a user interface element for modifying, by a subscriber, a suggested distribution schedule associated with a plurality of messages. In one of these embodiments, the second graphical user interface 630 includes a user interface element for modifying, by the subscriber, a frequency of delivery identified by the schedule. In another of these embodiments, the second graphical user interface 630 includes a user interface element for modifying, by the subscriber, an order of delivery of the plurality of messages 610. In still another of these embodiments, the second graphical user interface 630 includes the user interface element 470 described above in connection with FIG. 4C.

Referring now to FIG. 6B, a screen shot depicts one embodiment of a user interface element for requesting distribution of a plurality of messages. In one embodiment, the user interface element 632 enables the subscriber to select a subset of the plurality of messages, for example, by selecting a subset of chapters in the plurality of messages. In another embodiment, the user interface element 632 enables the subscriber to identify a version of the plurality of messages written in a particular language. In still another embodiment, the user interface element 632 enables the subscriber to request that each message be delivered only once.

In one embodiment, the second graphical user interface 630 includes a user interface element for requesting, by the subscriber, transmission of a subset of the plurality of messages. In another embodiment, the second graphical user interface 630 includes a user interface element for requesting, by the subscriber, transmission of all messages in the plurality of messages in a single transmission. In still another embodiment, the second graphical user interface 630 includes a user interface element for requesting, by the subscriber, transmission of a randomly-selected message from the plurality of messages.

Referring now to FIG. 6C, a screen shot depicts one embodiment of a user interface element for identifying destination addresses for use in delivering the plurality of messages to a subscriber. In one embodiment, the user interface element 634 provided by the second graphical user interface 630 enumerates a plurality of destination addresses provided by the subscriber. In another embodiment, the user interface element 634 enables the subscriber to modify existing destination addresses. In still another embodiment, the user interface element 634 enables the subscriber to identify a preferred destination address and secondary and backup destination addresses.

In one embodiment, the second graphical user interface 630 includes a user interface element for identifying, by the subscriber, an address of a mobile device for use in delivering a message in the plurality of messages via a short message service transmission. In another embodiment, the second graphical user interface 630 includes a user interface element for identifying, by the subscriber, an email address for use in delivering a message in the plurality of messages via an email transmission. In still another embodiment, the second graphical user interface 630 includes a user interface element for identifying, by the subscriber, an instant message username for use in delivering a message in the plurality of messages via an instant message service.

In some embodiments, the second graphical user interface 630 includes a user interface element for identifying, by the subscriber, an instant message service for use in delivering a message in the plurality of messages. In one of these embodiments, the instant messenger service is a real-time text messaging service for exchanging text between two computers connected over a network. In another of these embodiments, the instant messenger service is one of the following: Windows Live Messenger, AOL Instant Messenger, Yahoo! Messenger, Skype, Google Talk, .NET Messenger Service, Jabber, QQ, Excite/Pal iChat, ICQ, Gadu-Gadu, and Qnext. In still another of these embodiments, the instant messaging service is provided over an Internet Relay Chat channel. In yet another of these embodiments, the instant messaging service is provided by a UNIX-based system, such as a service using the UNIX “talk” command. In further embodiments, the instant messaging service supports multiple protocols, such as the clients provided by the Gaim, Trillian, and Miranda services. In other embodiments, a messaging service complying with a Session Initiation Protocol (SIP) standard or a SIP for Instant Messaging and Presence Leveraging Extensions (SIMPLE) standard is identified.

In one embodiment, the second graphical user interface 630 includes a user interface element for identifying, by the subscriber, a delivery method comprising delivering a message in the plurality of messages via an instant message service upon a failure of an attempt to transmit the message via short message service. In another embodiment, the second graphical user interface 630 includes a user interface element for identifying, by the subscriber, a delivery method comprising delivering a message in the plurality of messages via an email transmission upon a failure of an attempt to transmit the message via short message service. In still another embodiment, the second graphical user interface 630 includes a user interface element for identifying, by the subscriber, a delivery method comprising delivering a message in the plurality of messages via an email transmission upon a failure of an attempt to transmit the message via an instant message service. In yet another embodiment, the second graphical user interface 630 includes a user interface element for identifying, by the subscriber, a delivery method comprising delivering a message in the plurality of messages via a short message service upon a failure of an attempt to transmit the message via an instant message service.

Referring now to FIG. 6D, a screen shot depicts one embodiment of a first and second graphical user interface for distributing mobile book messages. In one embodiment, the first and second graphical user interfaces are displayed to the user as a single graphical user interface. In another embodiment, the first and second graphical user interfaces comprises nested user interfaces accessed by selecting a user interface element comprising a hypertext link to a nested user interface. In still another embodiment, the first and second graphical user interfaces include hypertext links for accessing additional user interfaces. The additional user interfaces may include, without limitation, links to libraries displaying summaries of pluralities of messages 610, interfaces displaying reviews of pluralities of messages 610 and requesting creation of additional reviews of pluralities of messages 610, forums for communication between authors of pluralities of messages 610 and users subscribed to services distributing the pluralities of messages 610, and sites offering for sale the original works of authorship summarized by the pluralities of messages 610.

Referring back to FIG. 6A, the transmitter 640 distributes to the subscriber, each message in the plurality of messages 610, responsive to the modified schedule and the delivery method. In one embodiment, the subscriber is a user of a client 100′, which comprises a mobile device, such as a mobile phone, smart phone, or other mobile device described above in connection with FIGS. 2A, 2B. In another embodiment, the transmitter sends a text message to the client 100′. In still another embodiment, the transmitter distributes the message in the plurality of messages 610 to the subscriber via a short message service.

In one embodiment, the transmitter distributes the message in the plurality of messages 610 to the subscriber via an email transmission. In another embodiment, the transmitter distributes the message in the plurality of messages 610 to the subscriber via an instant message service. In still another embodiment, the transmitter distributes the message via email or instant messenger when an attempt to distribute the message via text message or short message service fails.

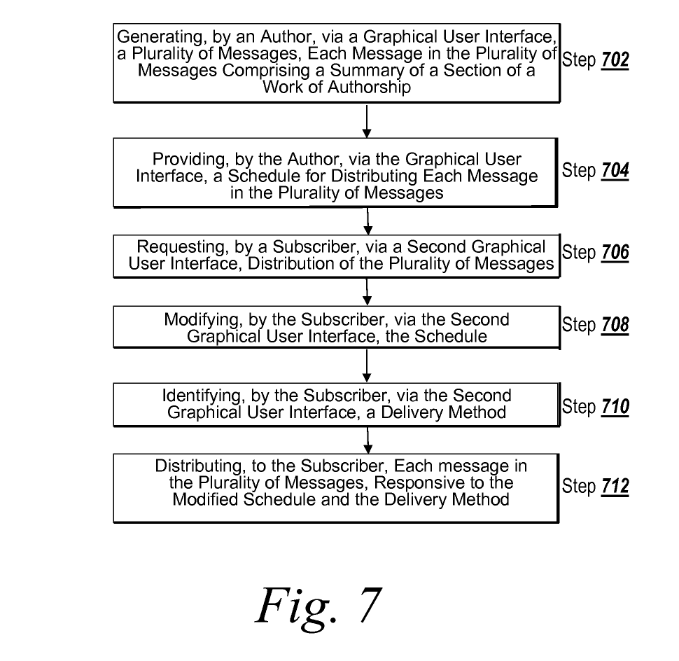

Referring now to FIG. 7, a flow diagram depicts one embodiment of the steps taken in a method for distributing mobile book messages. In brief overview, an author generates, via a graphical user interface, a plurality of messages, a message in the plurality of messages comprising a summary of a section of a work of authorship (step 702). The author provides, via the graphical user interface, a schedule for distributing each message in the plurality of messages (step 704). A subscriber requests, via a second graphical user interface, distribution of the plurality of messages (step 706). The subscriber modifies, via the second graphical user interface, the schedule (step 708). The subscriber identifies, via the second graphical user interface, a delivery method (step 710). Each message in the plurality of messages is distributed to the subscriber responsive to the modified schedule and the delivery method (step 712).

Referring to FIG. 7, and in greater detail, an author generates, via a graphical user interface, a plurality of messages, a message in the plurality of messages comprising a summary of a section of a work of authorship (step 702). The author provides, via the graphical user interface, a schedule for distributing each message in the plurality of messages (step 704). In one embodiment, the author generates a message having a character length of 160 characters. In another embodiment, the author generates a message summarizing a theme of the work of authorship. In still another embodiment, the author generates the plurality of messages and the schedule for distribution of the plurality of messages as described above in connection with FIG. 3. In yet another embodiment, the author generates a plurality of SMS-compliant messages and the schedule for distribution of the plurality of SMS-compliant messages as described above in connection with FIG. 5A.

A subscriber requests, via a second graphical user interface, distribution of the plurality of messages (step 706). In one embodiment, the subscriber interacts with the second graphical user interface to purchase a copy of the plurality of messages. In another embodiment, the subscriber elects to maintain the purchased copy of the plurality of messages on a server 140. In some embodiments, the subscriber requests transmission of the purchased copy of the plurality of messages in single transmission. In one of these embodiments, the subscriber retrieves the purchased copy of the plurality of messages from a server 140 on which the plurality of messages resides. In another of these embodiments, the subscriber requests transmission of a version of the plurality of messages in a document having a portable document format. In still another of these embodiments, the subscriber requests transmission of a version of the plurality of messages supported by a portable media player or digital audio device.

In other embodiments, the subscriber requests distribution of a purchased copy of the plurality of messages according to a schedule set by the author of the plurality of messages. In one of these embodiments, the subscriber requests distribution of a purchased copy of the plurality of messages according to a schedule set by the author of the plurality of messages and modified by the subscriber. In another of these embodiments, the subscriber requests distribution of a subset of the plurality of messages according to the schedule set by the author. In still another of the these embodiments, the subscriber requests distribution of a subset of the plurality of messages according to a schedule set by the author of the plurality of messages and modified by the subscriber.

In one embodiment, a subset of the messages is distributed to the subscriber periodically. In another embodiment, the messages are sent to the subscriber in chronological order. In still another embodiment, the messages are sent to the subscriber according to a theme of the work of authorship. In some embodiments, one message in the plurality of messages is divided and distributed to the subscriber as a plurality of short messages. In other embodiments, a subset of messages in the plurality of messages is distributed to the subscriber in a single transmission. In one of these embodiments, the subscriber selects the messages that comprise the subset. In another of these embodiments, the subscriber generates a “playlist”, or list of messages selected for distribution in a particular order.

The subscriber modifies, via the second graphical user interface, the schedule (step 708). In one embodiment, the subscriber modifies a frequency of delivery of the plurality of messages. In another embodiment, the subscriber modifies an order of delivery of a message in the plurality of messages. For example, the subscriber may specify a particular order of the plurality of messages, referred to in some embodiments as a playlist, and request distribution of the plurality of messages according to the specified order. In still another embodiment, the subscriber requests a transmission of all messages in the plurality of messages. In yet another embodiment, the subscriber requests a transmission of a randomly-selected message in the plurality of messages. For example, the subscriber may access a user interface element to subscribe to a random quote generator.

The subscriber identifies, via the second graphical user interface, a delivery method (step 710). In some embodiments, the subscriber associates a delivery method with a plurality of messages. In other embodiments, the subscriber identifies a delivery method for retrieving the plurality of messages in a single transmission. In one of these embodiments, the subscriber identifies a subset of the plurality of messages for retrieval in a single transmission.

In one embodiment, the subscriber identifies an address of a mobile device for use in delivering a message in the plurality of messages via a short message service transmission. In another embodiment, the subscriber identifies an instant message username for use in delivering a message in the plurality of messages via an instant messenger service. In still another embodiment, the subscriber identifies an email address for use in delivering a message in the plurality of messages via an email transmission.

In one embodiment, the subscriber identifies a preferred method of delivery of the plurality of messages. In another embodiment, the subscriber requests delivery of messages in the plurality of messages via a short message service. In some embodiments, the subscriber identifies a secondary method of delivery. In one of these embodiments, the subscriber identifies a delivery method comprising delivering a message in the plurality of messages via an instant message service upon a failure of an attempt to transmit the message via short message service. In another of these embodiments, the subscriber identifies a delivery method comprising delivering a message in the plurality of messages via an email transmission upon a failure of an attempt to transmit the message via short message service. In still another of these embodiments, the subscriber identifies a delivery method comprising delivering a message in the plurality of messages via an email transmission upon a failure of an attempt to transmit the message via an instant message service. In yet another embodiment, the subscriber identifies a delivery method comprising delivering a message in the plurality of messages via a short message service upon a failure of an attempt to transmit the message via an instant message service.

Each message in the plurality of messages is distributed to the subscriber responsive to the modified schedule and the delivery method (step 712). In one embodiment, the messages are distributed to the subscriber via a short message service. In another embodiment, the messages are distributed to the subscriber via an instant messenger services. In still another embodiment, the messages are distributed to the subscriber via email transmissions.

In one embodiment, the messages in the plurality of messages are associated with an order, for example, chronological order, order by theme, and order by chapter. In another embodiment, each message in the plurality of messages is sent in the order associated with the plurality of messages. In still another embodiment, each message in the plurality of messages is sent to the subscriber via a preferred delivery method specified by the subscriber. In yet another embodiment, if delivery via the preferred delivery method fails, the message in the plurality of messages is sent via a secondary delivery method. In a further embodiment, the preferred delivery method is used to send the message to a secondary destination address. For example, if transmission of an SMS message to one number associated with a mobile phone fails, the message may be sent to a second number associated with the subscriber.

In some embodiments, generation and distribution of the plurality of messages allows an author to provide materials to target audiences via mobile content, reach out to new audiences, and communicate with existing audiences. In other embodiments, distribution of the plurality of messages allows a subscriber to accomplish a variety of goals, including, but not limited to, studying for examinations, reviewing course materials, participating in study groups, staying connected to teachers and authors, reinforcing corporate training, sharing content with peers and colleagues, and maintaining focus and motivation in personal programs.

The following illustrative examples show how the methods and systems discussed above can be used for authoring, subscribing to, and controlling distribution of pluralities of messages summarizing works of authorship. These examples are meant to illustrate and not to limit the invention.

### EXAMPLE 1

In one embodiment, a user of the system connects to a web site to generate a summary of a work of authorship. In another embodiment, the user authors a plurality of messages that summarize the work of authorship. In still another embodiment, the author generates, via a graphical user interface displayed on the web site, a plurality of messages, each message in the plurality of messages comprising a summary of a section of a work of authorship. In yet another embodiment, the author generates, via the graphical user interface, a plurality of SMS-compliant messages.

In one embodiment, the author provides a schedule for distributing each message in the plurality of messages. In another embodiment, the author sets a suggested distribution schedule identifying which messages in the plurality of messages to distribute and in what order to distribute the messages.

In one embodiment, the author requests that the web site offer the plurality of messages for distribution via short message service. In another embodiment, the author sets a price that other users pay to receive distribution of the plurality of messages. In still another embodiment, the author requests that the web site offer the plurality of messages for distribution to a limited set of users, such as employees or colleagues of the author.

### EXAMPLE 2

In one embodiment, a user connects to a web site to browse a collection of mobile books. In another embodiment, the user connects to the web site to manage distribution of previously purchased mobile books.

In one embodiment, the user decides to subscribe to a distribution service for a mobile book. In another embodiment, the user pays for the distribution service. In still another embodiment, the user can subscribe to the distribution service at no cost.

In some embodiments, the user purchases a mobile book comprising a plurality of messages. In one of these embodiments, the user specifies an order of the plurality of messages. In another of these embodiments, the user creates a “playlist” defining an order of the plurality of messages. The specified order or playlist may be a specified chronological order, an order by chapter, or an order by theme. Additionally, the specified order or playlist may be chosen by theme. In another example, the user may provide one or more keywords via the graphical user interface, and a subset of the plurality of messages are selected for transmission according to the keywords.

In still another of these embodiments, the user requests retrieval of the plurality of messages, in the specified order, in a single transmission. For example, the user may download a PDF version of the plurality of messages. In another example, the user may download a version of the plurality of messages playable on a portable media device, or a digital audio player, such as an Apple iPod. In still another example, the user may download all messages in the plurality of messages to the user's computer.

In other embodiments, the user subscribes to a distribution service for a mobile book comprising a plurality of messages, and specifies a delivery schedule. In one of these embodiments, the user receives the plurality of messages over a period of time. In another of these embodiments, the user receives a subset of the plurality of messages periodically. In still another of these embodiments, the user controls the number of messages distributed and the frequency of distribution. For example, the user may request receipt of one message, or a subset of messages, every half hour, every hour, every six hours, every twelve hours, every day, every mealtime, and so on.

In still other embodiments, the user reads the plurality of messages upon receiving the distribution of the plurality of messages. In other embodiments, the user reads a subset of the messages upon receiving the distribution of the subset of the plurality of messages. In still other embodiments, the user requests a distribution of an additional message in the plurality of messages. In one of these embodiments, the user requests a previously-distributed message. In another of these embodiments, the user requests a randomly-selected message. In still other embodiments, the user receives on the user's computer a message in the plurality of messages and the message is displayed to the user as a screen saver.

In yet other embodiments, the user subscribes to a distribution service for a mobile book comprising a plurality of messages, and specifies a delivery method. In one of these embodiments, the user requests distribution of the plurality of messages via a plurality of SMS text messages transmitted to the user's mobile device. In another of these embodiments, the user requests distribution of the plurality of messages via a plurality of instant messages sent to an instant message username associated with the user on an instant messenger service. In still another of these embodiments, the user requests distribution of the plurality of messages via a plurality of electronic mail messages. In yet another of these embodiments, the user specifies a primary delivery method, such as a text message to a mobile phone, and specifies a backup, or secondary, delivery method, such as email transmission or instant message transmission, for use in the event that the primary delivery method fails.

The systems and methods described above may be provided as one or more computer-readable programs embodied on or in one or more articles of manufacture. The article of manufacture may be a floppy disk, a hard disk, a CD-ROM, a flash memory card, a PROM, a RAM, a ROM, or a magnetic tape. In general, the computer-readable programs may be implemented in any programming language, LISP, PERL, C, C++, PROLOG, or any byte code language such as JAVA. The software programs may be stored on or in one or more articles of manufacture as object code.

Having described certain embodiments of methods and systems for distributing mobile book messages, it will now become apparent to one of skill in the art that other embodiments incorporating the concepts of the invention may be used. Therefore, the invention should not be limited to certain embodiments, but rather should be limited only by the spirit and scope of the following claims.

What is claimed is:

1. A method for distributing mobile book messages, the method comprising the steps of:
(a) generating, by an author, via a graphical user interface, a plurality of messages, a message in the plurality of messages comprising a summary of a section of a work of authorship;
(b) providing, from the author, via the graphical user interface, a schedule for distributing each message in the plurality of messages;
(c) requesting, by a subscriber, via a second graphical user interface, distribution of the plurality of messages;
(d) modifying, by the subscriber, via the second graphical user interface, the schedule;
(e) identifying, by the subscriber, via the second graphical user interface, a delivery method; and
(f) distributing, to the subscriber, each message in the plurality of messages, responsive to the modified schedule and the delivery method.

2. The method of claim 1, wherein step (a) further comprises generating, by the author, a plurality of messages, each message in the plurality of messages having a character length of 160 characters.

3. The method of claim 1, wherein step (a) further comprises generating, by the author, a plurality of messages, each message in the plurality of messages comprising a summary of a theme of the work of authorship.

4. The method of claim 1, wherein step (d) further comprises modifying, by the subscriber, a frequency of delivery identified by the schedule.

5. The method of claim 1, wherein step (d) further comprises modifying, by the subscriber, in the schedule an order of delivery of the plurality of messages.

6. The method of claim 1, wherein step (d) further comprises providing, by the subscriber, a request to receive all messages in the plurality of messages in a single transmission.

7. The method of claim 1, wherein step (d) further comprises providing, by the subscriber, a request to receive transmission of a randomly selected message in the plurality of messages.

8. The method of claim 1, wherein step (e) further comprises identifying, by the subscriber, a subset of the plurality of messages for delivery in a single transmission.

9. The method of claim 1, wherein step (e) further comprises identifying, by the subscriber, an address of a mobile device for use in delivering a message in the plurality of messages via a short message service transmission.

10. The method of claim 1, wherein step (e) further comprises identifying, by the subscriber, an instant message username for use in delivering a message in the plurality of messages via an instant message service.

11. The method of claim 1, wherein step (e) further comprises identifying, by the subscriber, an email address for use in delivering a message in the plurality of messages via an email transmission.

12. The method of claim 1, wherein step (e) further comprises identifying, by the subscriber a delivery method comprising delivering a message in the plurality of messages via an instant message service upon a failure of an attempt to transmit the message via short message service.

13. The method of claim 1, wherein step (e) further comprises identifying, by the subscriber, a delivery method comprising delivering a message in the plurality of messages via an email transmission upon a failure of an attempt to transmit the message via short message service.

14. The method of claim 1, wherein step (e) further comprises identifying, by the subscriber, a delivery method comprising delivering a message in the plurality of messages via an email transmission upon a failure of an attempt to transmit the message via an instant message service.

15. The method of claim 1, wherein step (e) further comprises identifying, by the subscriber, a delivery method comprising delivering a message in the plurality of messages via a short message service upon a failure of an attempt to transmit the message via an instant message service.

16. The method of claim 1, wherein step (f) further comprises distributing the message to the subscriber via a short message service.

17. The method of claim 1, wherein step (f) further comprises distributing the message to the subscriber via email.

18. The method of claim 1, wherein step (f) further comprises distributing the message to the subscriber via an instant messenger service.

19. A system for distributing mobile book messages comprising:
a plurality of messages, each message in the plurality of messages comprising a summary of a section of a work of authorship;
a first graphical user interface displaying to an author a user interface element for submitting, by the author, i) the plurality of messages, ii) a schedule for distributing each message in the plurality of messages, and iii) a request to offer the plurality of messages for distribution;
a second graphical user interface displaying to a subscriber a user interface element for requesting distribution of the plurality of messages, for modifying the schedule, and for identifying a delivery method; and
a transmitter for distributing, to the subscriber, each message in the plurality of messages, responsive to the modified schedule and the delivery method.

20. The system of claim 19, wherein a message in the plurality of messages has a character length of 160 characters.

21. The system of claim 19, wherein a message in the plurality of messages further comprises a summary of a theme of a book.

22. The system of claim 19, wherein a message in the plurality of messages further comprises a summary of a section of a book.

23. The system of claim 19, wherein a message in the plurality of messages further comprises a summary of a section of a training manual.

24. The system of claim 19, wherein a message in the plurality of messages further comprises a summary of a section of a self-help book.

25. The system of claim 19, wherein a message in the plurality of messages further comprises a summary of a section of a religious text.

26. The system of claim 19, wherein a message in the plurality of messages further comprises a quote from the work.

27. The system of claim 19, wherein a message in the plurality of messages further comprises a test question.

28. The system of claim 27, wherein a message in the plurality of messages further comprises response to the test question.

29. The system of claim 19, wherein the second graphical user interface further comprises a user interface element for modifying, by the subscriber, a frequency of delivery identified by the schedule.

30. The system of claim 19, wherein the second graphical user interface further comprises a user interface element for modifying, by the subscriber, an order of delivery of the plurality of messages.

31. The system of claim 19, wherein the second graphical user interface further comprises a user interface element for requesting, by the subscriber, transmission of a subset of the plurality of messages.

32. The system of claim 19, wherein the second graphical user interface further comprises a user interface element for requesting, by the subscriber, transmission of all messages in the plurality of messages in a single transmission.

33. The system of claim 19, wherein the second graphical user interface further comprises a user interface element for requesting, by the subscriber, transmission of a randomly selected message in the plurality of messages.

34. The system of claim 19, wherein the second graphical user interface further comprises a user interface element for identifying, by the subscriber, an address of a mobile device for use in delivering a message in the plurality of messages via a short message service transmission.

35. The system of claim 19, wherein the second graphical user interface further comprises a user interface element for identifying, by the subscriber, an instant message username for use in delivering a message in the plurality of messages via an instant message service.

36. The system of claim 19, wherein the second graphical user interface further comprises a user interface element for identifying, by the subscriber, an email address for use in delivering a message in the plurality of messages via an email transmission.

37. The system of claim 19, wherein the second graphical user interface further comprises a user interface element for identifying, by the subscriber, a delivery method comprising delivering a message in the plurality of messages via an instant message service upon a failure of an attempt to transmit the message via short message service.

38. The system of claim 19, wherein the second graphical user interface further comprises a user interface element for identifying, by the subscriber, a delivery method comprising delivering a message in the plurality of messages via an email transmission upon a failure of an attempt to transmit the message via short message service.

39. The system of claim 19, wherein the second graphical user interface further comprises a user interface element for identifying, by the subscriber, a delivery method comprising delivering a message in the plurality of messages via an email transmission upon a failure of an attempt to transmit the message via an instant message service.

40. The system of claim 19, wherein the second graphical user interface further comprises a user interface element for identifying, by the subscriber, a delivery method comprising delivering a message in the plurality of messages via a short message service upon a failure of an attempt to transmit the message via an instant message service.

41. The system of claim 19, wherein the transmitter further comprises distributing the message to the subscriber via a short message service.

42. The system of claim 19, wherein the transmitter further comprises distributing the message to the subscriber via email.

43. The system of claim 19, wherein the transmitter further comprises distributing the message to the subscriber via an instant messenger service.
